(19) United States
(12) Patent Application Publication
(10) Pub. No.: US 2006/0116311 A1
(43) Pub. Date: Jun. 1, 2006

(54) Use of copolymers as auxiliaries for dyeing and printing textiles

(76) Inventors: Pia Baum, Wienheim (DE); Nicola Ulrike Kulzer, Mannheim (DE); Frank Funke, Ludwigshafen (DE); Andreas Bastian, Schauerberg (DE); Markus Ringelsbacher, Bad Durkheim (DE); Heinz Heissler, Frankenthal (DE); Gerhard Reuther, Weisenheim (DE); Rouven Konrad, Morstadt (DE); James David Carnahan, Niederkirchen (DE); Karl Siemensmeyer, Frankenthal (DE); Birgit Potthoff-Karl, Ludwigshafen (DE); Tarja Schneider, Bensheim (DE); Johann Muller, Worms (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/537,268

(22) PCT Filed: Nov. 28, 2003
(86) PCT No.: PCT/EP03/13463

§ 371 Date: Jun. 1, 2005

(30) Foreign Application Priority Data
Dec. 3, 2002 (DE) 102 56 618.6
Dec. 20, 2002 (DE) 102 61 190.4
May 12, 2003 (DE) 103 21 396.1

(51) Int. Cl. C11D 3/37

(52) U.S. Cl. 510/475

(57) ABSTRACT

The use of copolymers containing units derived from at least 2 monoethylenically unsaturated monomers B1 and B2 which each contain at least one nitrogenous heterocycle, as auxiliaries for textile dyeing and textile printing.

The present invention relates to the use of copolymers containing units derived from at least 2 monoethylenically unsaturated monomers B1 and B2 which each contain at least one nitrogenous heterocycle, as auxiliaries for textile dyeing and textile printing.

Modern textile dyeing typically employs not only colorants but also auxiliaries for textile dyeing. Desired effects of auxiliaries for textile dyeing are for example the removal of unwanted dyeings. Other auxiliaries for textile dyeing provide inter alia for particularly good and uniform dyeing and/or a good exhaustion of the colorants.

Particular examples of auxiliaries for textile dyeing are known to those skilled in the art as leveling agents. Other particular examples of auxiliaries for textile dyeing are known to those skilled in the art as stripping agents. Other particular examples of auxiliaries for textile dyeing are known to those skilled in the art as aftersoaping agents.

Textiles—natural and synthetic textiles for example—are frequently not absolutely homogeneous in their composition, but differ in composition or thickness along the length of the threads. One possible consequence is that the dyed textile has relatively more deeply and relatively more lightly dyed areas, which is generally undesirable. To achieve a uniform dyeing, leveling agents are used, for example. Leveling agents are agents which bring about uniform dyeing across the area of the textile to be dyed and specifically along the length of the thread. Prior art leveling agents include oil sulfonates, fatty alcohol sulfonates, fatty acid condensation products, alkyl and alkylaryl polyglycol ethers.

Leveling agents further influence the dyeing characteristics of the dyes and especially the exhaustion characteristics. Dyes having high affinity for fiber shall be kept back in the liquor for longer and migrate more readily on the fiber. It is desirable that leveling agents lead to more uniform (more level) dyeings as a result.

Known leveling agents include leveling agents based on polyvinylpyrrolidone, see Ullmann's Encyclopedia of Industrial Chemistry (5th edition) volume A26, page 291, left-hand column. Commercially available leveling agents further include condensates of adipic acid and amines such as for example H₂N—CH₂CH₂—NH—(CH₂)₃—NH₂ or H₂N—CH₂CH₂—NH—(CH₂)₃—NH—CH₂CH₂—NH₂. However, the performance properties of such conventional leveling agents, for example when used as leveling agents for leveling vat, direct, reactive or sulfur dyes, are still in need of improvement.

Stripping agents are generally agents useful for removing for example dyeings, prints and impregnations by redetaching, altering or destroying a dye. A particularly important area of use for stripping agents is the correction of off-shade dyeings. This involves dye on off-shade dyeings being lightened in order that the off-shade dyeing may be re- or overdyed.

Stripping agents are also known as a component of discharge print pastes. Discharge print pastes are used to remove certain colors in discharge printing. In discharge printing, a color is generally printed uniformly. It is then overprinted with a subsequent color. The subsequent color is then removed again in some areas by means of a discharge print paste.

However, prior art stripping agents are still in need of improvement with regard to their performance properties.

Reactive-, direct- or vat-dyed textiles are customarily aftercleared at the end of the dyeing operation and prior to marketing in order that unfixed dye remaining on the fiber may be removed in order that an adequate fastness level may be achieved. Afterclearing typically involves at least one soaping bath and plural rinsing and neutralizing baths. The result of the afterclear is influenced by the chemicals present in the dyebath, especially the salt burden. The soaping bath for the afterclear is made up to include a compound which disperses the dye or decomposition products of the dye and which is generally known as an aftersoaping agent. Known aftersoaping agents have disadvantages in that many known aftersoaping agents are observed to give an ineffective performance especially in the presence of salts such as for example Glauber's salt and/or sodium chloride in the soaping bath. Furthermore, the known aftersoaping agents have to be used at high temperatures, ie at around 98° C. Moreover, the performance of polyacrylic acids and polyvinylpyrrolidones used as aftersoaping agents still leaves something to be desired.

It is an object of the present invention to provide an improved process for afterclearing reactive-, direct- or vat-dyed textiles, hereinafter also referred to as dyed textiles. It is a further object of the present invention to provide aftersoaping agents which give an improved performance in the afterclearing of dyed textiles and which specifically are effective at elevated concentrations of salts in the soaping bath.

Reactive-, direct- or vat-dye printed textiles are customarily aftercleared also at the end of the textile printing operation and prior to marketing in order that unfixed dye remaining on the fiber may be removed in order that an adequate fastness level may be achieved. Afterclearing typically involves at least one soaping bath and plural rinsing and neutralizing baths. The result of the afterclear is influenced by the chemicals used in textile printing, especially the salt burden. The soaping bath for the afterclear is made up to include a compound which disperses the dye or decomposition products of the dye and which is generally known as an aftersoaping agent. Known aftersoaping agents have disadvantages in that many known aftersoaping agents are observed to give an ineffective performance especially in the presence of salts such as for example Glauber's salt and/or sodium chloride in the soaping bath. Furthermore, the known aftersoaping agents have to be used at high temperatures, ie at around 98° C. Moreover, the performance of polyacrylic acids and polyvinylpyrrolidones used as aftersoaping agents still leaves something to be desired.

It is an object of the present invention to provide an improved process for afterclearing reactive-, direct- or vat-dye printed textiles, hereinafter also referred to as printed textiles. It is a further object of the present invention to provide aftersoaping agents which give an improved performance in the afterclearing of printed textiles and which specifically are effective at elevated concentrations of salts in the soaping bath.

We have found that this object is achieved by the above-defined auxiliaries for textile dyeing and textile printing.

Textiles for the purposes of the present invention are textile fibers, textile intermediate and end products and finished articles manufactured therefrom which, as well as textiles for the apparel industry, also include for example carpets and other home textiles and also textile structures for industrial purposes. These also include unshaped structures such as for example staples, linear structures such as twine, filaments, yarns, lines, strings, laces, braids, cordage and threads and also three-dimensional structures such as for example felts, wovens, nonwovens and waddings. Textiles can be of natural origin, for example cotton, wool or flax, or synthetic, for example polyamide.

In one embodiment of the present invention, copolymers used in the textile dyeing and textile printing auxiliaries of the present invention (which copolymers will hereinafter also be referred to as copolymers used according to the present invention) contain units derived from at least 2 monoethylenically unsaturated monomers B1 and B2 which each contain at least one nitrogenous heterocycle.

The copolymers used according to the present invention can be random copolymers, block copolymers or graft polymers.

In one embodiment of the present invention, the B1 monomer present in copolymerized form in the copolymers used according to the present invention is at least one cyclic amide of the general formula I 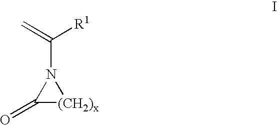
where
x is an integer from 1 to 6 and
R¹ is hydrogen or C₁-C₄-alkyl, such as methyl, ethyl, n-propyl, isopropyl, n-butyl, isobutyl, sec-butyl and tert-butyl.

Specific examples of a copolymerized B1 monomer are N-vinylpyrrolidone, N-vinyl-δ-valerolactam and N-vinyl-ε-caprolactam, of which N-vinylpyrrolidone is preferred.

In one embodiment of the present invention, the copolymers used according to the present invention contain units derived from at least one B2 monomer which contains a nitrogenous heterocycle selected from the group consisting of pyrroles, pyrrolidines, pyridines, quinolines, isoquinolines, purines, pyrazoles, imidazoles, triazoles, tetrazoles, indolizines, pyridazines, pyrimidines, pyrazines, indoles, isoindoles, oxazoles, oxazolidones, oxazolidines, morpholines, piperazines, piperidines, isoxazoles, thiazoles, isothiazoles, indoxyls, isatins, dioxindoles and hydantoins and derivatives thereof, for example barbituric acid and uracil and derivatives thereof.

Preferred heterocycles are imidazoles, pyridines and pyridine N-oxides, and imidazoles are particularly preferred.

Examples of particularly useful B2 comonomers are N-vinylimidazoles, alkylvinylimidazoles, especially methylvinylimidazoles such as 1-vinyl-2-methylimidazole, 3-vinylimidazole N-oxide, 2- and 4-vinylpyridines, 2- and 4-vinylpyridine N-oxides and also betainic derivatives and quaternization products thereof.

Very particularly preferred copolymerized B2 comonomers are N-vinylimidazoles of the general formula II a, betainic N-vinylimidazoles of the general formula IIb, 2- and 4-vinylpyridines of the general formula IIc and IId and also betainic 2- and 4-vinylpyridines of the general formula IIe and IIf 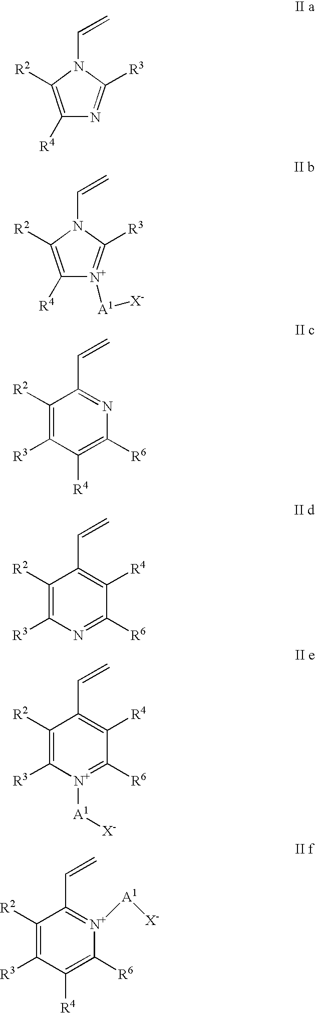
where
R², R³, R⁴, R⁶ are independently hydrogen, C₁-C₄-alkyl such as methyl, ethyl, n-propyl, isopropyl, n-butyl, isobutyl, sec-butyl and tert-butyl; or phenyl, preferably hydrogen;
A¹ is C₁-C₂₀-alkylene, for example —CH₂—, —CH(CH₃)—, —(CH₂)₂—, —CH₂—CH(CH₃)—,
   —(CH₂)₃—, —(CH₂)₄—, —(CH₂)₅—, —(CH₂)₆—, preferably C₁-C₃-alkylene; especially —CH₂—, —(CH₂)₂— or —(CH₂)₃—.
X^{- is —SO}₃⁻, —OSO₃—, —COO⁻, —OPO(OH)O^{-, —OPO(OR}⁵)O⁻ or —PO(OH)O⁻;
R⁵ is C₁-C₂₄-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl,
   n-decyl; particularly preferably C₁-C₄-alkyl such as methyl, ethyl, n-propyl, isopropyl, n-butyl, isobutyl, sec-butyl and tert-butyl.

Examples of especially preferred betainic copolymerized B2 monomers are monomers of the formulae IIb, IIe and IIf where the A¹-X⁻ moiety represents —CH₂—COO⁻, —(CH₂)₂—SO₃⁻ or (CH₂)₃—SO₃— and the other symbols each represent hydrogen.

Useful B2 monomers further include vinylimidazoles and vinypyridines which were each quaternized before or after polymerization.

The quaternization may be carried out especially with alkylating agents such as alkyl halides which generally have from 1 to 24 carbon atoms in the alkyl radical or dialkyl sulfates which generally contain alkyl radicals of 1 to 10 carbon atoms. Examples of useful alkylating agents from these groups are methyl chloride, methyl bromide, methyl iodide, ethyl chloride, ethyl bromide, propyl chloride, hexyl chloride, dodecyl chloride and lauryl chloride and also dimethyl sulfate and diethyl sulfate. Useful alkylating agents further include for example: benzyl halides, especially benzyl chloride and benzyl bromide; chloroacetic acid; methyl fluorosulfate; diazomethane; oxonium compounds, such as trimethyloxonium tetrafluoroborate; alkylene oxides, such as ethylene oxide, propylene oxide and glycidol, which are used in the presence of acids; cationic epichlorohydrins. Preferred quaternizing agents are methyl chloride, dimethyl sulfate and diethyl sulfate.

Examples of particularly useful quaternized B2 monomers are 1-methyl-3-vinylimidazolium methosulfate and 1-methyl-3-vinylimidazolium methocloride.

The weight ratio of the copolymerized B1 and B2 monomers is generally in the range from 99:1 to 1:99, preferably in the range from 90:10 to 30:70, more preferably in the range from 90:10 to 50:50, even more preferably in the range from 80:20 to 50:50 and especially in the range from 80:20 to 60:40.

The copolymers used according to the present invention may contain units derived from one or more further monomers B3, for example carboxyl-containing monoethylenically unsaturated monomers, for example unsaturated C₂-C₁₀ mono- or dicarboxylic acids and their derivatives such as salts, esters, amides and anhydrides. Examples which may be mentioned are:

acids and their salts such as for example (meth)acrylic acid, fumaric acid, maleic acid and their respective alkali metal or ammonium salts;

anhydrides such as for example maleic anhydride;

esters such as for example methyl(meth)acrylate, ethyl(meth)acrylate, n-butyl(meth)acrylate, dimethyl maleate, diethyl maleate, dimethyl fumarate, diethyl fumarate, di-n-butyl fumarate.

Further examples of B3 are vinyl acetate and vinyl propionate and also ethylenically unsaturated compounds of the general formula IIIa to IIId, 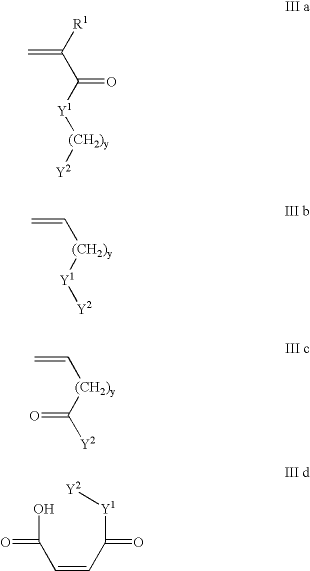
where
R¹ is as defined above,
Y¹ is selected from oxygen or NH,
y is an integer selected from 1 or 0,
Y² is [A²-O]ₛ-[A³-O]ᵤ-[A⁴-O]ᵥ—R⁸
A² to A⁴ are the same or different and independently —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;
R⁸ is hydrogen, amino-C₁-C₆-alkyl, wherein the amino group may be a primary, secondary or tertiary amino group, for example CH₂—NH₂, —(CH₂)₂—NH₂, —CH₂—CH(CH₃)—NH₂,
   —CH₂—NHCH₃, —CH₂—N(CH₃)₂, —N(CH₃)₂, —NHCH₃, —N(C₂H₅)₂; C₁-C₂₄-alkyl; R⁹—CO—, R⁹—NH—CO—;
R⁹ is C₁-C₂₄-alkyl;
R¹⁰ is hydrogen, C₁-C₂₄-alkyl, R⁹—CO—;
s denotes integers in the range from 0 to 500;
u is at each instance the same or different and denotes integers in the range from 1 to 5000 in each case;
v is at each instance the same or different and denotes integers in the range from 0 to 5000 in each case;
w is at each instance the same or different and denotes integers in the range from 0 to 5000 in each case.

The C₁-C₂₄-alkyl radicals in the formula IIIa to IIId can be branched or unbranched C₁-C₂₄-alkyl radicals, in which C₁-C₁₂-alkyl radicals are preferred and C₁-C₆-alkyl radicals are particularly preferred. Examples which may be mentioned are methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and n-eicosyl.

In a specific embodiment, the process according to the present invention comprises using one or more graft polymers as a copolymer in the process according to the present invention.

Graft polymers which are preferably used include for example those which, as well as the B1 and B2 monomers, also contain units derived from such B3 comonomers as conform to the formulae IIIa to IIId.

A preferred embodiment utilizes graft polymers constructed from

a polymeric grafting base A which contains no monoethylenically unsaturated units, and

polymeric side chains B formed from copolymers of at least two monoethylenically unsaturated monomers B1 and B2 which each contain at least one nitrogenous heterocycle and optionally further comonomers B3.

The graft polymers which are used in the hereinbelow described embodiment of the process according to the present invention and which may have a comb construction can be characterized by their ratio of side chains B to polymeric grafting base A. Said side chains B may account for more than 35% by weight, based on the total graft polymer. The fraction is preferably in the range from 55 to 95% by weight and more preferably in the range from 70 to 90% by weight.

The B1 monomer incorporated in the B side chains of the graft polymers is preferably at least one cyclic amide of the general formula I 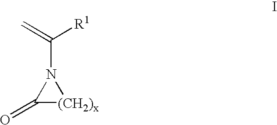
where the symbols in the formula I are each as defined above.

Specific examples of a copolymerized B1 monomer are N-vinylpyrrolidone, N-vinyl-δ-valerolactam and N-vinyl-ε-caprolactam, of which N-vinylpyrrolidone is preferred.

In one embodiment of the present invention, the B side chains advantageously contain units derived from at least one monoethylenically unsaturated B2 monomer which contains a nitrogenous heterocycle selected from the group consisting of pyrroles, pyrrolidines, pyridines, quinolines, isoquinolines, purines, pyrazoles, imidazoles, triazoles, tetrazoles, indolizines, pyridazines, pyrimidines, pyrazines, indoles, isoindoles, oxazoles, oxazolidones, oxazolidines, morpholines, piperazines, piperidines, isoxazoles, thiazoles, isothiazoles, indoxyls, isatins, dioxindoles and hydantoins and derivatives thereof, for example barbituric acid and uracil and derivatives thereof.

Preferred heterocycles are imidazoles, pyridines and pyridine N-oxides, and imidazoles are particularly preferred.

Examples of particularly useful B2 comonomers are N-vinylimidazoles, alkylvinylimidazoles, especially methylvinylimidazoles such as 1-vinyl-2-methylimidazole, 3-vinylimidazole N-oxide, 2- and 4-vinylpyridines, 2- and 4-vinylpyridine N-oxides and also betainic derivatives and quaternization products thereof.

Very particularly preferred copolymerized B2 comonomers are N-vinylimidazoles of the general formula IIa, betainic N-vinylimidazoles of the general formula IIb, 2- and 4-vinylpyridines of the general formula IIc and IId and also betainic 2- and 4-vinylpyridines of the general formula IIe and IIf

Examples of especially preferred betainic copolymerized B2 monomers are monomers of the formulae IIb, IIe and IIf where the A¹-X⁻ moiety represents —CH₂—COO⁻, —(CH₂)₂—SO₃⁻ or (CH₂)₃—SO₃— and the other symbols each represent hydrogen.

Useful B2 monomers further include vinylimidazoles and vinypyridines which were each quaternized before or after polymerization.

The quaternization can be carried out in particular as described above.

Examples of particularly useful quaternized B2 monomers are 1-methyl-3-vinylimidazolium methosulfate and 1-methyl-3-vinylimidazolium methocloride.

The weight ratio of the copolymerized B1 and B2 monomers is generally in the range from 99:1 to 1:99, preferably in the range from 90:10 to 30:70, more preferably in the range from 90:10 to 50:50, even more preferably in the range from 80:20 to 50:50 and especially in the range from 80:20 to 60:40.

The side chains of the graft polymers used according to the present invention may contain units derived from one or more further monomers B3, for example carboxyl-containing monoethylenically unsaturated monomers, for example unsaturated C₂-C₁₀ mono- or dicarboxylic acids and their derivatives such as salts, esters, anhydrides and those which are defined above.

The polymeric grafting base A of the graft polymers used according to the present invention is preferably a polyether. Here, the term “polymeric” shall also comprehend oligomeric compounds.

Particularly preferred polymeric grafting bases A have an average molecular weight Mₙ of at least 300 g.

Particularly preferred polymeric grafting bases A have the general formula IVa 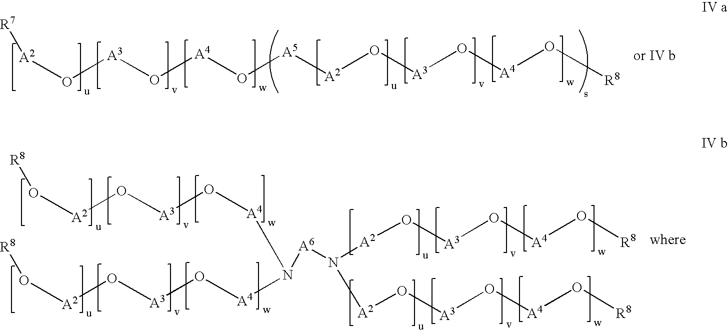
R⁷ is hydroxyl, amino, C₁-C₂₄-alkoxy such as for example methoxy, ethoxy, n-propoxy, isopropoxy, n-butoxy, isobutoxy, sec-butoxy, tert-butoxy, n-pentoxy, isopentoxy, n-hexoxy, isohexoxy, R⁹—COO—, R⁹—NH—COO—, polyalcohol radical such as for example glycerinyl;
A² to A⁴ are the same or different and each is —(CH₂)₂—, —(CH₂)₃—, —(CH₂)₄—, —CH₂—CH(CH₃)—, —CH₂—CH(CH₂—CH₃)—, —CH₂—CHOR¹⁰—CH₂—;
R⁸ is hydrogen, amino-C₁-C₆-alkyl, wherein the amino group may be a primary, secondary or tertiary amino group, for example CH₂—NH₂, —(CH₂)₂—NH₂, —CH₂—CH(CH₃)—NH₂,
   —CH₂—NHCH₃, —CH₂—N(CH₃)₂, —N(CH₃)₂, —NHCH₃, —N(C₂H₅)₂;
   C₁-C₂₄-alkyl;
   R⁹—CO—, R⁹—NH—CO—;
A⁵ is —CO—O—, —CO—B—CO—O—, —CO—NH—B—NH—CO—O—;
A⁶ is C₁-C₂₀-alkylene whose carbon chain may be interrupted by 1 to 10 oxygen atoms as ether functions;
B is —(CH₂)ₜ—, arylene, for example paraphenylene, metaphenylene, orthophenylene, 1,8-naphthylene, 2,7-naphthylene, substituted or unsubstituted;
n is 1 or, when R⁷ is a polyalcohol radical, from 1 to 8;
t represents integers in the range from 1 to 12;
and the other symbols are each as defined above.

The polymeric grafting bases A of the formula IVa are preferably polyethers from the group of the polyalkylene oxides based on ethylene oxide, propylene oxide and butylene oxides, polytetrahydrofuran and also polyglycerol. Depending on the monomers, the resulting polymers contain the following structural units:
—(CH₂)₂—O—, —(CH₂)₃—O—, —(CH₂)₄—O—, —CH₂—CH(CH₃)—O—, —CH₂—CH(CH₂—CH₃—O—, —CH₂—CHOR⁸—CH₂—O—

Both homopolymers and copolymers are useful, and the copolymers may be random copolymers or block copolymers.

The terminal primary hydroxyl groups of the polyethers prepared on the basis of alkylene oxides or glycerol and also the secondary OH groups of polyglycerol may be present in free form or else be etherified with C₁-C₂₄-alcohols, esterified with C₁-C₂₄-carboxylic acids or reacted with isocyanates to form urethanes. Useful alcohols for this purpose are for example: primary aliphatic alcohols, such as methanol, ethanol, propanol and butanol, primary aromatic alcohols, such as phenol, isopropylphenol, tert-butylphenol, octylphenol, nonylphenol and naphthol, secondary aliphatic alcohols, such as isopropanol, tertiary aliphatic alcohols, such as tert-butanol and polyhydric alcohols, for example diols, such as ethylene glycol, diethylene glycol, propylene glycol, 1,3-propanediol and butanediol, and triols, such as glycerol and trimethylolpropane. However, the hydroxyl groups may also be exchanged for primary amino groups (by reductive amination with hydrogen-ammonia mixtures under pressure) or converted by cyanoethylation with acrylonitrile and hydrogenation into aminopropylene end groups. The conversion of the hydroxyl end groups may not only take place subsequently through reaction with alcohols or with aqueous alkali metal hydroxide solutions, amines and hydroxylamines, but these compounds may also be used like Lewis acids, for example boron trifluoride, as initiators at the start of the polymerization. Finally, the hydroxyl end groups may also be etherified by reaction with alkylating agents, such as dimethyl sulfate.

The C₁-C₂₄-alkyl radicals in the formula IVa and IVd can be branched or unbranched C₁-C₂₄-alkyl radicals, in which C₁-C₁₂-alkyl radicals are preferred and C₁-C₆-alkyl radicals are particularly preferred. Examples which may be mentioned are methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-ethylhexyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and n-eicosyl.

The average molecular weight Mₙ of the polyethers of the general formula IVa is at least 300 g/mol and generally ≦100 000 g/mol. It is preferably in the range from 500 g/mol to 50 000 g/mol, more preferably in the range up to 10 000 g/mol and most preferably in the range up to 2000 g/mol. The polydispersity of the polyethers of the general formula IVa is low, for example in the range from 1.1 to 1.8, in most cases.

It is possible to use homo- and copopolymers of ethylene oxide, propylene oxide, butylene oxide and isobutylene oxide, which may each be linear or branched, as a polymeric grafting base A. As used herein, the term homopolymers also comprehends polymers which, as well as the polymerized alkylene oxide unit, additionally contain the reactive molecules which were used to initiate the polymerization of the cyclic ethers or to end group cap the polymer.

Branched polymers can be prepared by for example adding to low molecular weight polyalcohols (R⁷ radicals in the formula IVa and IVb), for example pentaerythritol, glycerol and sugars or sugar alcohols, such as sucrose, D-sorbitol and D-mannitol, disaccharides, ethylene oxide and, if desired, propylene oxide and/or butylene oxides or else polyglycerol.

In the polymers formed, at least one, preferably from one to eight and more preferably from one to five of the hydroxyl groups present in the polyalcohol molecule can be linked in the form of an ether bond to the polyether radical of the formula IVa or IVb.

Four-arm polymers are obtainable by adding the alkylene oxides to diamines, preferably ethylenediamine.

Further branched polymers are preparable by reacting alkylene oxides with higher amines, for example triamines, or especially polyethyleneimines. Suitable polyethyleneimines for this generally have average molecular weights Mₙ in the range from 300 to 20 000 g, preferably in the range from 500 to 10 000 g and more preferably in the range from 500 to 5000 g. The weight ratio of alkylene oxide to polyethyleneimine is customarily in the range from 100:1 to 0.1:1, and preferably in the range from 20:1 to 0.5:1.

It is also possible to use polyesters of polyalkylene oxides and aliphatic C₁-C₁₂—, preferably C₁-C₆—, dicarboxylic acids or aromatic dicarboxylic acids, for example oxalic acid, succinic acid, adipic acid or terephthalic acid, having average molecular weights Mₙ in the range from 1500 to 25 000 g/mol as a polymeric grafting base A.

It is further possible, instead of IVa and IVb, to use phosgenation-prepared polycarbonates of polyalkylene oxides or else polyurethanes of polyalkylene oxides and aliphatic C₁-C₁₂-diisocyanates and preferably C₁-C₆-diisocyanates or aromatic diisocyanates, for example hexamethylene diisocyanate or phenylene diisocyanate, as a polymeric grafting base A.

These polyesters, polycarbonates or polyurethanes can contain up to 500 and preferably up to 100 polyalkylene oxide units, in which case polyalkylene oxide units can consist not only of homopolymers but also of copolymers of different alkylene oxides.

Particular preference is given to using homo- and copolymers of ethylene oxide and/or propylene oxide as a polymeric grafting base A for the process according to the present invention, which can be singly or doubly end group capped or tipped.

One effect of polypropylene oxide and copolymeric alkylene oxides having a high propylene oxide fraction is that grafting takes place easily.

One effect of polyethylene oxide and copolymeric alkylene oxides having a high ethylene oxide fraction is that, after grafting has taken place and has produced a graft polymer having the same graft density as polypropylene oxide, the weight ratio of side chain to polymeric grafting base is larger.

The K values of the graft polymers are customarily in the range from 10 to 150, preferably in the range from 10 to 80 and more preferably in the range from 15 to 60 (determined after H. Fikentscher, Cellulose-Chemie, volume 13, pages 58 to 64 and 71 to 74 (1932) in water or 3% by weight aqueous sodium chloride solutions at 25° C. and polymer concentrations ranging from 0.1% by weight to 5% by weight, depending on the K value range). The particular K value desired can be set in a conventional manner through the composition of the materials used. For a 100% theoretical degree of grafting, the molecular weight of the products is given by the molecular weight of the grafting base and the fraction of the comonomers which react as side chains. The greater the number of molecules used as the grafting base, the greater the number of final molecules obtained, and vice versa. Side chain density is controllable via initiator quantity and the reaction conditions.

A further process for preparing the graft polymers used according to the present invention comprises free-radically polymerizing the monomers B1 and B2 and optionally further comonomers B3 in the presence of the polymeric grafting base A.

The polymerization can be carried out for example as a solution polymerization, bulk polymerization, emulsion polymerization, inverse emulsion polymerization, suspension polymerization, inverse suspension polymerization or precipitation polymerization. Preference is given to bulk polymerization and especially solution polymerization, which is carried out in the presence of water in particular.

A bulk polymerization can be carried out by dissolving the monomers B1 and B2 in the polymeric grafting base A, heating the mixture to the polymerization temperature and adding a free-radical initiator before polymerizing the mixture to completion. The polymerization can also be carried out semicontinuously by initially charging a portion, for example 10% by weight, of the mixture of polymeric grafting base A, monomer B1 and B2 and free-radical initiator and heating the mixture to the polymerzation temperature and, after the polymerization has lighted off, adding the rest of the mixture at a rate commensurate with the progress of the polymerization. However, it is also possible to initially charge the polymeric grafting base A to a reactor, to heat the initial charge to polymerization temperature and to add monomer B1 and B2 (separately or as a mixture) and the free-radical initiator either all at once, batchwise or preferably continuously before polymerizing.

The graft polymerization described above can be carried out in one or more solvents. Useful organic solvents are for example aliphatic and cycloaliphatic monohydric alcohols, such as methanol, ethanol, n-propanol, isopropanol, n-butanol, sec-butanol, tert-butanol, n-hexanol and cyclohexanol, polyhydric alcohols, for example glycols, such as ethylene glycol, propylene glycol and butylene glycol, and glycerol, alkyl ethers of polyhydric alcohols, for example methyl and ethyl ethers or the dihydric alcohols mentioned, and also ether alcohols, such as diethylene glycol and triethylene glycol, and also cyclic ethers, such as dioxane.

The graft polymerization is preferably carried out in water as a solvent. Here, A, B1 and B2 and optionally further comonomers B3 are more or less effectively dissolved, depending on the amount of water used. The water, in part or in whole, can also be added in the course of the polymerization. It will be appreciated that it is also possible to use mixtures of water and the abovementioned organic solvents.

It is customary to use from 5 to 250% by weight and preferably from 10 to 150% by weight of organic solvent, water or mixture of water and organic solvent, based on the graft polymer.

The polymerization in water generally provides from 10 to 70% by weight, and preferably from 20 to 50% by weight of solutions or dispersions of the graft polymers according to the present invention, which can be converted into powder form by means of various drying processes, for example spray drying, fluidized spray drying, drum drying or freeze drying. An aqueous solution or dispersion can then easily be reestablished by adding water at the desired time.

Useful free-radical initiators are in particular peroxo compounds, azo compounds, redox initiator systems and reducing compounds. It will be appreciated that it is also possible to use mixtures of free-radical initiators.

Examples of suitable free-radical initators are specifically: alkali metal peroxodisulfates, for example sodium peroxodisulfate, ammonium peroxodisulfate, hydrogen peroxide, organic peroxides, such as diacetyl peroxide, di-tert-butyl peroxide, diamyl peroxide, dioctanoyl peroxide, didecanoyl peroxide, dilauroyl peroxide, dibenzoyl peroxide, bis(o-toluoyl)peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate; azobisisobutyronitrile, azobis(2-amidopropane)dihydrochloride and 2,2′-azobis(2-methylbutyronitrile); sodium sulfite, sodium bisulfite, sodium formaldehydesulfoxylate and hydrazine and combinations of the aforementioned compounds with hydrogen peroxide; ascorbic acid/iron(II) sulfate/Na₂S₂O₈, tert-butyl hydroperoxide/sodium disulfite and tert-butyl hydroperoxide/sodium hydroxymethanesulfinate.

Preferred free-radical initiators are for example tert-butyl perpivalate, tert-butyl peroctoate, tert-butyl perneodecanoate, tert-butyl peroxide, tert-butyl hydroperoxide, azobis(2-methylpropion-amidine)dihydrochloride, 2,2′-azobis(2-methylbutyronitrile), hydrogen peroxide and sodium peroxodisulfate, to which redox metal salts, for example iron salts, can be added in small amounts.

It is customary to use from 0.01 to 10% by weight, and preferably from 0.1 to 5% by weight of free-radical initiator, based on the monomers B1 and B2.

If desired, it is also possible to use polymerization regulators. Useful compounds are known to one skilled in the art and include for example sulfur compounds, such as mercaptoethanol, 2-ethylhexyl thioglycolate, thioglycolic acid and dodecyl mercaptan, but other types of regulator as well, for example bisulfite and hypophosphite. When polymerization regulators are used, their use level is generally in the range from 0.1 to 15% by weight, preferably in the range from 0.1 to 5% by weight and more preferably in the range from 0.1 to 2.5% by weight, based on monomers B1 and B2.

The polymerization temperature is generally in the range from 30 to 200° C., preferably in the range from 50 to 150° C. and more preferably in the range from 75 to 110° C.

The polymerization is customarily carried out under atmospheric pressure, but can also be carried out under reduced or elevated pressure, for example at 0.5 or 5 bar.

According to the present invention, the copolymers described above are used as stripping agents for example. According to the present invention, the copolymers described above can be used as leveling agents.

A further embodiment of the present invention comprises the use according to the present invention of at least one graft polymer on a grafting base comprising a copolymer which contains units derived from monomers B1 and B2 and the textile print and optionally further comonomers B3, the monomers B1, B2 and B3 being as defined above, as an auxiliary for textile dyeing and textile printing.

The present invention further provides auxiliaries for textile dyeing and textile printing (stripping agents, leveling agents and aftersoaping agents, for example) which include the copolymers described above.

Textile dyeing and textile printing auxiliaries of the present invention, for example stripping agents, leveling agents and aftersoaping agents, more preferably include at least one graft polymer constructed from a polymeric grafting base A which contains no monoethylenically unsaturated units, and polymeric side chains B formed from copolymers of at least two monoethylenically unsaturated monomers B1 and B2 which each contain at least one nitrogenous heterocycle and optionally further comonomers B3.

Preferably, the fraction of side chains B in the textile dyeing and textile printing auxiliaries of the present invention, for example in the stripping agents, leveling agents and aftersoaping agents of the present invention, is greater than 35% by weight.

Preferred textile dyeing and textile printing auxiliaries according to the present invention, in addition to the above-described copolymers and especially the above-described graft polymers, additionally include further components, for example phosphorus compounds, complexing agents and ionic or nonionic surfactants, and examples of particularly suitable phosphorus compounds are phosphonic acid compounds, for example hydroxymethylidenediphosphonic acid. Suitable complexing agents are amino carboxylic acid derivatives and their alkali metal salts, for example nitrilotriacetic acid, ethylenediaminetetraacetic acid and also the corresponding di- and trisodium salts and also the tetrasodium salt of ethylenediaminetetraacetic acid. Examples of suitable nonionic surfactants are ethoxylation products of long-chain alcohols. Preferred alcohols belong for example to the group of 1-alkanols having 8 to 30 carbon atoms and preferably 8 to 18 carbon atoms or of 2-alkanols having 8 to 30 and preferably 8 to 18 carbon atoms. The degree of ethoxylation is in the range from 4 to 30 and preferably in the range from 6 to 15.

Preference is further given to alkoxylation products of the abovementioned alkanols, having an average degree of alkoxylation in the range from 8 to 30 and preferably from 8 to 18, subject to the proviso that at least 1 mol of propylene oxide was used. Alkoxylation products mentioned by way of example are obtained by reaction of alkanols with propylene oxide initially and ethylene oxide subsequently.

Suitable ionic surfactants are based for example on mono- or diesters of sulfosuccinic acid. Suitable alcohols for preparing the esters are branched or unbranched alcohols having a chain length from 2 to 30 carbon atoms and preferably from 4 to 18 carbon atoms.

The textile dyeing and textile printing auxiliaries of the present invention can be used as a powder. But they can also be used as an aqueous formulation, in which case the water fraction can be in the range from 5 to 95 and preferably from 20 to 90% by weight, based on the sum total of the components. Preference is given to the use as a liquid formulation whose metering can be accomplished using an automatic metering range for example.

The present invention further provides a process for leveling off-shade dyeings or unlevel dyeings in the case of textile materials, hereinafter also referred to as leveling process of the present invention, which comprises using a leveling agent comprising at least one copolymer which contains units derived from at least 2 monoethylenically unsaturated monomers B1 and B2 which each contain at least one nitrogenous heterocycle.

In one embodiment of the present invention, the leveling process of the present invention relates to the elimination of off-shade dyeings or unlevel dyeings due to vat, direct, reactive or sulfur dyes.

One embodiment of the leveling process of the present invention utilizes the graft polymers described above.

The leveling process of the present invention can be carried out under otherwise known conditions.

Preferably, the leveling process of the present invention is carried out in aqueous liquor, in which case the liquor ratio can be in the range from 100:1 to 5:1 and preferably in the range from 25:1 to 5:1.

The concentration of the leveling agents of the present invention, based on the level of above-described copolymer, is in the range from 0.01 to 10 g/l of liquor, especially in the range from 0.1 to 1 g/l and especially 1 g/l of liquor.

In one embodiment of the present invention, one or more dispersants are added to the liquor. Examples of suitable dispersants are naphthalenesulfonic acid-formaldehyde condensation products, which are preparable for example by sulfonation of naphthalene with oleum, partial or full neutralization with for example aqueous alkali metal hydroxide solution and reaction with formaldehyde. Other suitable dispersants are described for example in U.S. Pat. No. 4,218,218. Suitable amounts are generally in the range from 0.1 to 5 g of dispersant/l of liquor and preferably in the range from 1 to 2 g/l.

In one embodiment of the present invention, one or more reducing agents are added to the liquor, for example sodium dithionite Na₂S₂O₄. Suitable amounts are generally in the range from 0.1 to 10 g of reducing agent/l of liquor and especially in the range from 1 to 6 g/l.

In one embodiment of the present invention, protective colloids are added to the liquor, for example protective colloids based on partially or fully neutralized polyacrylic acids. Suitable polyacrylic acids have an average molecular weight M_{w} which is for example in the range from 1000 to 200 000 g/mol, preferably in the range from 1000 to 100 000 g/mol and especially in the range from 3000 to 70 000 g/mol. Very particular preference is given to fully neutralized polyacrylic acids. Suitable amounts are generally in the range from 0.1 to 5 g of protective colloid/l of liquor and especially in the range from 1 to 2 g/l.

The leveling process of the present invention is customarily carried out at a pH in the range from 9 to 13.

The leveling process of the present invention is customarily carried out at a temperature above room temperature. Temperatures in the range from 50° C. to boiling temperature and preferably at least 60° C. are particularly suitable.

The duration of the leveling process according to the present invention is customarily at least 5 minutes to 2 hours, and preferably in the range from 30 to 90 minutes.

The treatment with the leveling agents of the present invention can be followed by rinsing, washing and/or drying. It is also sensible to neutralize with acids, especially with low-volatile acids such as for example succinic acid, adipic acid, tartaric acid or citric acid.

The present invention further provides a process for stripping off-shade dyeings off textile materials, hereinafter also referred to as stripping process of the present invention, which comprises using a stripping agent comprising at least one copolymer which contains units derived from at least 2 monoethylenically unsaturated monomers B1 and B2 which each contain at least one nitrogenous heterocycle.

In one embodiment of the present invention, the stripping process of the present invention relates to the elimination of off-shade dyeings due to vat, direct, reactive or sulfur dyes.

One embodiment of the stripping process of the present invention utilizes the graft polymers described above.

The stripping process of the present invention can be carried out under otherwise known conditions.

Preferably, the stripping process of the present invention is carried out in aqueous liquor, in which case the liquor ratio can be in the range from 100:1 to 5:1 and preferably in the range from 25:1 to 5:1.

The concentration of the stripping agents of the present invention, based on the level of above-described copolymer, is in the range from 0.5 to 10 g/l of liquor, especially in the range from 2 to 4 g/l of liquor.

In one embodiment of the present invention, one or more dispersants are added to the liquor. Examples of suitable dispersants are naphthalenesulfonic acid-formaldehyde condensation products, which are preparable for example by sulfonation of naphthalene with oleum, partial or full neutralization with for example aqueous alkali metal hydroxide solution and reaction with formaldehyde. Other suitable dispersants are described for example in U.S. Pat. No. 4,218,218. Suitable amounts are generally in the range from 0.1 to 5 g of dispersant/l of liquor and preferably in the range from 1 to 2 g/l.

In one embodiment of the present invention, one or more reducing agents are added to the liquor, for example sodium dithionite Na₂S₂O₄. Suitable amounts are generally in the range from 0.1 to 10 g of reducing agent/l of liquor and especially in the range from 1 to 6 g/l.

In one embodiment of the present invention, protective colloids are added to the liquor, for example protective colloids based on partially or fully neutralized polyacrylic acids. Suitable polyacrylic acids have an average molecular weight M_{w} which is for example in the range from 1000 to 200 000 g/mol, preferably in the range from 1000 to 100 000 g/mol and especially in the range from 3000 to 70 000 g/mol. Very particular preference is given to fully neutralized polyacrylic acids. Suitable amounts are generally in the range from 0.1 to 5 g of protective colloid/l of liquor and especially in the range from 1 to 2 g/l.

The stripping process of the present invention is customarily carried out at a pH in the range from 9 to 13.

The stripping process of the present invention is customarily carried out at a temperature above room temperature. Temperatures in the range from 50° C. to boiling temperature and preferably at least 60° C. are particularly suitable.

The duration of the stripping process of the present invention is customarily at least 5 minutes to 2 hours, and preferably in the range from 30 to 90 minutes.

The treatment with the stripping agents of the present invention can be followed by rinsing, washing and/or drying. It is also sensible to neutralize with acids, especially with low-volatile acids such as for example succinic acid, adipic acid, tartaric acid or citric acid.

The present invention further provides a process for afterclearing dyed or printed textile hereinafter also referred to as inventive afterclearing process or inventive aftersoaping process.

The aftersoaping process of the present invention is practiced using one or more aftersoaping agents of the present invention in a typically aqueous liquor. The liquor may include foreign salts, for example NaCl or Glauber's salt, in amounts of up to 15% by weight, based on the liquor. The water used to prepare the aqueous liquor need not be softened; water hardnesses of up to 30° of German hardness are possible.

The aftersoaping process of the present invention can be practiced at atmospheric pressure, but superatmospheric pressures such as 1.1 to 5 bar for example are possible as well.

To practice the aftersoaping process of the present invention, dyed or printed textiles may be treated in one or more soaping baths in each of which the temperature, pressure and pH conditions may be chosen to be the same or different. Preference is given to using from one to three soaping baths and more preferably one or two soaping baths. Preferably, the pressure and temperature conditions in the different soaping baths are the same.

When plural soaping baths are to be used, it is customary for the spent liquors to be disposed of between the individual soaping baths and for new liquors to be made up in each case. It is possible to use soaping baths having the same composition or else soaping baths having different compositions. However, at least one soaping bath shall contain one or more of the aftersoaping agents of the present invention.

The concentration in the soaping bath or baths of the aftersoaping agents used according to the present invention is customarily in the range from 1 to 8 g/l and preferably in the range from 1 to 4 g/l.

The aftersoaping process of the present invention may utilize at least one further component to further improve the afterclearing of the textiles.

Useful further components include for example nonionic surfactants, for example polyalkoxylated fatty alcohols. They may be alkoxylated with for example ethylene oxide, propylene oxide or butylene oxide or mixtures thereof; preference is given to ethylene oxide. Useful alcohols include C₁₀-C₂₄-alcohols, and especially C₁₂-C₁₈-alcohols. Degrees of alkoxylation range from 10 to 40 equivalents of alkoxide per equivalent of fatty alcohol, especially from 15 to 30 equivalents of alkoxide per equivalent of fatty alcohol and especially from 20 to 25 equivalents of alkoxide per equivalent of fatty alcohol. The degree of alkoxylation here must in each case be understood as an average value.

Further components which may be used in the aftersoaping process of the present invention are complexing agents, for example phosphorus compounds such as polyphosphates or alkylidenebisphosphonic acid compounds such as hydroxymethylidenebisphosphonic acid. Also suitable are aminoacetic acid derivatives such as nitrilotriacetic acid or ethylenediaminetetraacetic acid and the respective corresponding alkali metal salts.

The quantitative ratios of the various components in the aftersoaping process of the present invention are in themselves not critical.

The pH of the soaping bath or baths used in the process of the present invention is in the range from 4 to 12 and preferably in the range from 5 to 11. It is particularly preferable for the pH to be neutral or slightly acidic. The pH is customarily set using organic carboxylic acids such as for example aliphatic monocarboxylic acids such as acetic acid, formic acid, propionic acid, aliphatic dicarboxylic acids such as for example adipic acid, succinic acid, citric acid or polycarboxylic acids. Very particular preference is given to carboxylic acids which have only a very low vapor pressure at room temperature. Accordingly, aliphatic dicarboxylic acids, citric acid and polycarboxylic acids are preferred.

Aliphatic dicarboxylic acids which are preferably used have the general formula
HO₂C—(CH₂)ᵢ—(O—(CH₂)ⱼ)ₖ—CO₂H
where i, j and k are independently from 0 to 9. Particular preference is given to carboxylic acids in which k is 0 or 1 and i and j are independently from 1 to 6. Very particular preference is given to carboxylic acids in which i and j are independently from 1 to 4 and k is 0 or 1. Especial preference is given to mixtures of these carboxylic acids or mixtures of these carboxylic acids with citric acid.

Aliphatic dicarboxylic acids which are preferably used are succinic acid, glutaric acid, adipic acid, 2-methylsuccinic acid, 2-methylglutaric acid, 3-methylglutaric acid.

Polycarboxylic acids which are preferably used belong to the class of the polyacrylic acids and their copolymers with maleic acids. They have an average molecular weight Mₙ in the range from 1 000 to 150 000 g/mol and preferably in the range from 2 000 to 70 000 g/mol.

The aftersoaping process of the present invention is customarily carried out at elevated temperatures. Possible temperatures range from 50 to 100° C. and may be even higher under superatmospheric pressure. Preference is given to temperatures in the range from 60 to 98° C.

The mass ratio of liquor to dyed or printed textile to be aftercleared is customarily in the range from 1:4 to 1:40 and preferably in the range from 1:6 to 1:20. The liquor containing the textile may be agitated during the afterclear. The treatment time per soaping bath is in itself not critical and is typically in the range from 5 minutes to 10 hours and preferably in the range from 10 to 30 minutes.

The aftersoap is typically followed by a rinse of the textiles with water. It is customary to employ from 1 to 6 and preferably from 2 to 4 rinse cycles. The only or the first rinse baths typically employ hot water, ie water at a temperature in the range from 35 to 70° C. The last rinsing operations often take place in the range from room temperature to 40° C.

The aftersoaping process of the present invention provides very efficiently aftercleared textiles which contain only extremely low amounts of unfixed dye and hence have a very good wash- and contactfastness level.

The present invention further provides aftersoaping agents whose use makes the process of the present invention particularly efficient. The aftersoaping agents of the present invention comprise at least one copolymer containing units derived from at least 2 monoethylenically unsaturated monomers B1 and B2 which each contain at least one nitrogenous heterocycle. Exemplary copolymers are described above.

Preferably, the copolymer in the aftersoaping agents of the present invention is a graft polymer. Exemplary graft polymers are described above.

The aftersoaping agents of the present invention more preferably comprise at least one graft polymer constructed from

a polymeric grafting base A which contains no monoethylenically unsaturated units, and polymeric side chains B formed from copolymers of at least two monoethylenically unsaturated monomers B1 and B2 which each contain at least one nitrogenous heterocycle and optionally further comonomers B3.

Preferably, the side chains B account for more than 35% by weight of the aftersoaping agents of the present invention.

Preferred aftersoaping agents, as well as the graft polymers described above, additionally comprise further components, for example phosphorus compounds and nonionic surfactants. Particularly suitable phosphorus compounds and nonionic surfactants are described above.

The aftersoaping agents of the present invention may be used as a powder. But they may also be used as an aqueous formulation, in which case the water fraction can be in the range from 5% to 95% and preferably from 20% to 90% by weight, based on the sum total of the components. Preference is given to the use as a liquid formulation whose metering can be accomplished using an automatic metering range for example.

The present invention further provides for the use of the aftersoaping agents of the present invention to afterclear textiles which have been dyed with reactive dyes, direct dyes or vat dyes. Similarly, the present invention provides a process for afterclearing reactive-, direct- or vat-dyed textiles subsequent to dyeing and to remove dye not fixed to the textile.

The present invention likewise relates to a process for afterclearing reactive-, direct- or vat-printed textiles, wherein the afterclearing operation follows the coloring operation and serves to remove dye not bound to the textile.

The invention is illustrated by working examples.

### EXAMPLES

### 1. Synthesis of Copolymers and Graft Polymers Used According to the Present Invention

### 1.1. Synthesis of Graft Polymer 1

In a reactor equipped with nitrogen supply, reflux condenser, stirrer and metering means, 10 g of polyethylene glycol having an average molecular weight M_{w} of 600 g/mol (Pluriol®E, BASF Aktiengesellschaft) and 56.2 g of water were heated to an internal temperature of about 85° C. under nitrogen. A mixture of 27.5 g of N-vinylpyrrolidone and 12.5 g of N-vinylimidazole was then added continuously in the course of 3¼ hours. At the same time as this mixture, 0.8 g of 2,2′-azobis(2-methylpropionamidine)dihydrochloride (V50®, from Wako Chemicals) was added continuously in the course of 3¼ hours. On completion of the addition, the batch was cooled down to 60° C. On attainment of this temperature, 0.3 g of tert-butyl hydroperoxide in 1.72 ml of water was added. This was followed by the addition of 0.2 g of Na₂S₂O₅ in 6.26 ml of water. A clear, slightly yellow polymer solution was obtained. The solids content was 42% by weight.

The K value was determined after H. Fikentscher, Cellulose-Chemie volume 13, pages 58-64 and 71-74 and at 25° C. in 3% by weight aqueous NaCl solution and found to be 40.

### 1.2. Synthesis of Copolymer 1

A mixture of 125 g of N-vinylpyrrolidone, 125 g of N-vinylimidazole and 600 g of water were initially charged to a flask and heated to 85° C. in a nitrogen atmosphere with stirring. As soon as 85° C. was reached, 1.53 g of 2,2′-azobis(2-aminopropane)dihydrochloride dissolved in 27 ml of water were added over 2 h. In addition, a solution of 5 g of mercaptoethanol dissolved in 27 ml of water was metered in over an hour. On completion of the metered addition the reaction mixture was stirred at 85° C. for 2 hours and then cooled down to 60° C. 2.2 g of t-butyl hydroperoxide(70% by weight in water) were diluted with 2 g of water and this dilute solution was added very rapidly. This was followed by the addition over 5 minutes of 1.53 g of Na₂S₂O₅ dissolved in water, and further stirring at 60° C. for 2 hours. A yellow, clear and low-odor polymer solution was obtained. The K value of the copolymer was 32. The molecular weight M_{w} was 50 000 g/mol. The aqueous solution had a solids content of 30% by weight.

### 2. Performance Testing

### 2.1. Performance Testing as a Leveling Agent

Amounts stated as percentages are based on weight of fiber. Amounts not stated in percentages are based on liquor volume.

### Inventive Example 2.1.1

A liquor consisting of 0.3% by weight of Indanthren Golden Orange G Colliosol, 0.5% by weight of Indanthren Dark Blue BOA Colliosol, 12 ml of 38°BE caustic soda, 0.5 g/l of graft polymer 1, 5 g/l of Na₂S₂O₄, made up to a liquor volume of 1 l, was vatted without textile at 60° C. for 10 min.

25 g of bleached cotton cheesecloth (sample 1) were wound on a perforated metal basket and dyed at 60° C. in a dyeing vessel which was an airtightly sealable stainless steel cylinder 15 cm in diameter and 30 cm in height for 3 min 40 s. Subsequently, the dyeing vessel was opened and after a total dyeing time of 4 min a further 25 g of bleached cotton cheesecloth (sample 2), wound on a perforated metal basket, were introduced into the dyeing vessel. The dyeing vessel was resealed and dyed at 60° C. for a further 45 min. Subsequently, the dyed cotton cheesecloth was removed and rinsed three times by immersion in 1 l of cold water.

Subsequently, the dyed cotton cheesecloth (samples 1 and 2) was oxidized in 1 l of liquor containing 2 ml/l of 50% by weight hydrogen peroxide solution at 55° C. for 5 min. This was followed by an overflow rinse with water at room temperature for 5 min.

Subsequently, samples 1 and 2 were cleared in a soap bath at 98° C. for 15 min. The soap bath had the following composition: liquor volume 1 l containing 1 g/l of 90% by weight aqueous C₁₃H₂₇—(OCH₂CH₂)₄—OH and 0.5 g/l of Na₂CO₃. Subsequently, the sample was rinsed once more at 55° C. for 1 min. Finally, samples 1 and 2 were whizzed and dried. This provided leveled samples 1 and 2.

To evaluate the effectiveness of graft polymer 1 as a leveling agent, samples 1 and 2 were colorimetrically compared in terms of depth of shade.

The reflectance spectrum was recorded with an X-rite CA22 spectrometer for sample 1 (as reference) and then for the bleached cotton cheesecloth. The Kubelka-Munk K/S values were calculated for each spectrum. Subsequently, the K/S values of the bleached cotton cheesecloth were deducted from that of sample 1 to obtain the pure dye contribution to the K/S value of sample 1.

The same procedure was carried out for sample 2 to obtain the pure dye contribution to the K/S value of sample 2.

The obtained pure dye contributions to the K/S values were then ratioed in the region of the peak of the wavelength-dependent depiction of the K/S values of sample 2. For this, the K/S value of sample 1 was set equal to 100%. The higher the K/S value of sample 2 was compared with the K/S value of sample 1, the better the leveling performance.

A very good leveling performance on the part of the leveling agents examined should lead to sample 1 and sample 2 having an identical depth of shade.

### Comparative Example V 2.1.2

Inventive Example 2.1.1 was repeated, except that graft polymer 1 was replaced by polyvinylpyrrolidone 1 having a molecular weight M_{w} of 45 000 g/mol and a Fikentscher K value of 31, determined in 1% by weight aqueous solution.

TABLE 1
Colorimetric values of performance tests of leveling agents

| | | Depth of shade | |
|---|---|---|---|
| Example No. | Leveling agent used | Sample 1 | Sample 2 |
| 2.1.1 | 0.5 g/l of graft polymer 1 | 100% | 85% |
| V 2.1.2 | 0.5 g/l of polyvinylpyrrolidone 1 | 100% | 65% |

2.2. Performance testing as a stripping agent

The performance as a stripping agent was tested on a predyeing with a vat dye.
Percentages are based on weight of the bleached textile. All other stated amounts are based on liquor volume.

### Inventive Example 2.2.1

Use according to the present invention of graft polymer 1 as a stripping agent A predyeing was carried out according to the following recipe:

In a dyeing vessel comprising an airtightly sealable stainless steel cylinder 15 cm in diameter and 30 cm in height, 1% by weight of Vat Orange 2, 0.5 g/l of a condensate of 1 equivalent of adipic acid and 0.5 equivalent each of N3-amine:H₂N—CH₂CH₂—NH—(CH₂)₃NH₂; N4-amine: H₂N—CH₂CH₂—NH—(CH₂)₃—NH—CH₂CH₂—NH₂, 12 ml of 38° BE caustic soda and 5 g/l of Na₂S₂O₄ (as an 88% by weight powder) were mixed, made up with water to 1 l and entered with 50 g of bleached cotton cheesecloth. The dyeing vessel was sealed. For dyeing, the temperature was then raised over 10 min from room temperature to 60° C., which temperature was maintained for 45 min.

Subsequently, the predried cotton cheesecloth was removed and rinsed three times with 1 liter of room temperature water.

Subsequently, the predyed cotton cheesecloth was oxidized in 1 l of water containing 2 ml/l of 50% by weight hydrogen peroxide solution at 55° C. for 5 min, overflow rinsed at room temperature for 1 min and subsequently whizzed and dried.

For stripping, a blank dyeing liquor, ie a dyeing liquor without colorant, was prepared to contain 12 ml/l of 38° BE caustic soda, 6 g/l of Na₂S₂O₄ and 2 g/l of graft polymer 1. For stripping, 50 g of the above-described predyed cotton cheesecloth were introduced into the blank dyeing liquor, heated to 80° C. over 20 min and then treated at 80° C. for 45 min. Subsequently, the temperature was lowered to 60° C. over 10 min and the cotton cheesecloth thus pretreated removed at 60° C. It was again rinsed three times in about 1 l of cold water and subsequently oxidized with 1 l of liquor containing 2 ml/l of 50% by weight hydrogen peroxide solution at 55° C. for 5 min.

This was followed by overflow rinsing for 1 min and a subsequent 15 min soap at 98° C. in a liquor containing 1 g/l of 90% by weight aqueous C₁₃H₂₇—(OCH₂CH₂)₄—OH and 0.5 g/l of Na₂CO₃. Finally, a further overflow rinse with water was carried out at 55° C. for 1 min, followed by whizzing and drying to obtain treated cotton cheesecloth.

The reflectance spectrum was recorded with an X-rite CA22 spectrometer for predyed cotton cheesecloth (as reference) and then for the bleached cotton cheesecloth. The Kubelka-Munk K/S values were calculated for each spectrum. Subsequently, the K/S values of the bleached cotton cheesecloth were deducted from that of predyed cotton cheesecloth to obtain the pure dye contribution to the K/S value of predyed cotton cheesecloth.

The same procedure was carried out for the cleared sample to obtain the pure dye contribution to the K/S value of the treated cotton cheesecloth.

The obtained pure dye contributions to the K/S values were then ratioed in the region of the peak of the wavelength-dependent depiction of the K/S values of the predyed cotton cheesecloth. For this, the K/S value of predyed cotton cheesecloth was set equal to 100%. The higher the K/S value of the treated cotton cheesecloth was compared with the K/S value of predyed cotton cheesecloth, the worse the stripping performance.

A very good stripping performance should mean that the sample has a depth of shade which is comparable to the cotton fabric used or that dyeing should no longer be detectable. The values for the stripping result are reported in % depth of shade of the predyed cotton cheesecloth.

### Comparative Example V 2.2.2

### Inventive Example 2.2.1

was repeated, except that graft polymer 1 was replaced by polyvinylpyrrolidone 1 having a molecular weight M_{w} of 45 000 g/mol and a Fikentscher K value of 31, determined in 1% by weight aqueous solution.

TABLE 2
Tests with stripping agents

| | | Depth of shade | |
|---|---|---|---|
| | | predyed cotton | treated cotton |
| Example No. | Stripping agent | cheesecloth | cheesecloth |
| 2.2.1 | Graft polymer 1 | 100% | 2.3% |
| V 2.2.2 | Polyvinylpyrrolidone 1 | 100% | 15.6% |

2.3 Performance testing as an aftersoaping agent

### 2.3.1. General Prescription for Preparing the Hydrolyzed Reactive Dye

The hydrolyzed reactive dyes/reactive dye mixtures needed for the preliminary dyeing were prepared by admixing solutions of the commercial reactive dyes listed in table 1 in the amounts reported in table 1 with 40 ml of 38° Be aqueous sodium hydroxide solution, made up with water to 1 l and adjusted with CaCl₂ to 20° German hardness. This was followed by heating from room temperature to 98° C. over 30 min. The hydrolyzates thus obtainable were maintained at 98° C. for 120 min and then cooled down to room temperature over 30 min. The hydrolyzates were transferred to brown glass bottles for storage. The use levels of the dyes used for the hydrolyzates H1 to H8 are recited in table 3.

The abbreviations used for the reactive systems have the following meanings:

MCT monochlorotriazine

MFT monofluorotriazine

DA-MCT bireactive monochlorotriazine

VS vinyl sulfone.

TABLE 3
Hydrolyzates H1 to H8

| | Hydrolyzate | | | | | | | |
|---|---|---|---|---|---|---|---|---|
| | H1 | H2 | H3 | H4 | H5 | H6 | H7 | H8 |
| Procion Orange H-ER | 12.5 | | | | | | | |
| Procion Rot 7B | 12.5 | | | | | | | |
| Procion Blau H-ERD | 12.5 | | | | | | | |
| Cibacron Gelb LS-R | | 12.5 | | | | | | |
| Cibacron Rot LS-6G | | 12.5 | | | | | | |
| Cibacron Blau LS-3R | | 12.5 | | | | | | |
| Levafix Brilliant Rot E-RN | | | 12.5 | | | | | |
| Procion Türkis H-EXL | | | | 12.5 | | | | |
| Procion Karminrot H-EXL | | | | | 12.5 | | | |
| Procion Smaragd H-EXL | | | | | | 12.5 | | |
| Remazol Gelb GR | | | | | | | 12.5 | |
| Remazol Brillant Orange | | | | | | | 12.5 | |
| 3R Remazol Bril. Blau BB | | | | | | | 12.5 | |
| Procion Gelb H-EXL | | | | | | | | 12.5 |
| Procion Karminrot H-EXL | | | | | | | | 12.5 |
| Procion Marine H-EXL | | | | | | | | 12.5 |
| Reactive system | MCT | DA-MCT | MFT | DA-MCT | DA-MCT | DA-MCT | VS | DA-MCT |

2.3.2. General prescription for preparing the preliminary dyeings with hydrolyzates

The dye hydrolyzate quantity discernible from table 3 was made up to 1 l with water and adjusted to 20° German hardness with CaCl₂. An HVF12085 pad-mangle from Mathis was used to apply the thus diluted hydrolyzates to woven cotton fabric. The contact pressure of the rolls was 2.6 bar. The resulting wet pickup was 80%. The application speed was 2 m/min. The textile was subsequently dried in an LTF89534 circulating air cabinet from Mathis at 125° C. for 4 min without air circulation. The depth of shade of the padded textile thus obtained was determined by means of an X-rite CA22 reflectance spectrometer and the calculation carried out as described above. The padded nonaftercleared textile will hereinafter also be referred to as padded textile.

### 2.3.3. General Prescription for Washing off the Reactive Dye (Tests V1 to 60)

The table 2 use level of the respective table 2 aftersoaping agent were dissolved with 50 g of sodium chloride in 1 l of water and adjusted to 10° German hardness with CaCl₂. 200 ml of the liquor thus obtained were temperature controlled to 60° C. Citric acid was used if necessary to adjust the pH to the value reported in table 5. The liquor was entered with 10 g of a padded textile and heated over 10 min to the temperature reported in table 5. Each soaping bath was allowed to act for 15 min before cooling down to 60° C., and in those examples where more than one soaping bath was used the liquor was in each case disposed of after the first soaping bath and a new soaping bath was set. In the experiments, to this end the second soaping bath in each case was with identical. The textile was removed and expressed by hand. This was followed by two rinses with 200 ml of cold water each time for 5 minutes each time. This is followed by whizzing and drying of the sample at room temperature.

The afterclearing effect was evaluated as follows.

The reflectance spectrum was recorded with an X-rite CA22 spectrometer for the padded, dried textile as reference and then for the untreated textile. The Kubelka-Munk K/S values were calculated for both the textiles. Subsequently, the K/S values of the untreated textile were deducted from the padded, dried textile to obtain the pure dye contribution to the K/S value of the padded, dried textile.

The same procedure was carried out with the aftercleared sample to obtain the pure dye contribution to the K/S value of the aftercleared textile.

The obtained pure dye contributions to the K/S values were then ratioed in the region of the peak of the wavelength-dependent depiction of the K/S values of the padded, dried textile. For this, the K/S value of the padded, dried textile was set equal to 100%. The higher the K/S value of the aftercleared textile compared with the nonaftercleared padded, dried textile, the worse the aftersoaping performance.

The aftersoaping agents used were the substances or mixtures S1 to S8 reported below in table 4.

TABLE 4
Composition of inventive aftersoaping agents S2
to S7 and of comparative aftersoaping agent S1

| | Aftersoaping agent | | | | | | |
|---|---|---|---|---|---|---|---|
| | S1 | S2 | S3 | S4 | S5 | S6 | S7 |
| Polyacrylic acid | 100 | | | | | | |
| 1-Hydroxymethylidenebis- | | | 25 | 10 | 31.5 | | |
| phosphonic acid | | | | | | | |
| Copolymer 1 | | 100 | | | | | |
| Graft polymer 1 | | | 25 | 10 | 35 | 35 | 100 |
| n-C₁₆H₃₃—(OCH₂CH₂)₂₅—OH | | | 2.5 | 2.5 | 3.5 | | |
| Water | | | 47.5 | 77.5 | 30 | 65 | |

The polyacrylic acid used for the aftersoaping agent S1 used in comparative examples is NaOH neutralized polyacrylic acid having an M_{w} of 70 000 g, determined by gel permeation chromatography; pH 8.5, as 45% by weight aqueous solution. Comparative examples V2, V4, V6 and V8 utilized soaping baths free of aftersoaping agent, ie the treatment of the padded textile was carried out with hot water at the reported pH.

n-C₁₆H₃₃—(OCH₂CH₂)₂₅—OH is ethoxylated hexadecanol prepared according to the following prescription:

242 g of stearyl alcohol and 0.1 mol of KOH flakes were dewatered in an autoclave at 100° C. and 1 mbar over 2 hours, decompressed with nitrogen and rinsed 3 times with nitrogen and then heated to 130° C. in the autoclave. On reaching 130° C., 1100 g of ethylene oxide were continuously metered in at a pressure of up to 6.1 bar over 3 h 20 min. On completion of the addition the reaction was allowed to proceed until constant pressure was reached. This was followed by cooling down to 100° C.

TABLE 5
Inventive aftersoaping examples and comparative examples

| | Example | | | | | | | | | |
|---|---|---|---|---|---|---|---|---|---|---|
| | V1 | V2 | V3 | V4 | V5 | V6 | V7 | V8 | 9 | 10 |
| Hydrolyzate No. | H3 | H3 | H5 | H5 | H3 | H3 | H5 | H5 | H3 | H5 |
| Amount of hydrolyzate | 1.25 | 1.25 | 1.25 | 1.25 | 1.25 | 1.25 | 1.25 | 1.25 | 1.25 | 1.25 |
| used [g] | | | | | | | | | | |
| Depth of shade of | 100 | 100 | 100 | 100 | 100 | 100 | 100 | 100 | 100 | 100 |
| padded textile | | | | | | | | | | |
| Aftersoaping agent | S1 | none | S1 | none | S1 | none | S1 | none | S2 | S2 |
| Amount of aftersoaping | 2 | — | 2 | — | 2 | — | 2 | — | 2 | 2 |
| agent used [g/l] | | | | | | | | | | |
| Number of soaping baths | 2 | 2 | 2 | 2 | 2 | 2 | 2 | 2 | 2 | 2 |
| Temperature of soaping | 98 | 98 | 98 | 98 | 98 | 98 | 98 | 98 | 98 | 98 |
| bath/baths [° C.] | | | | | | | | | | |
| pH | 6.5 | 6.5 | 6.5 | 6.5 | 11 | 11 | 11 | 11 | 6.5 | 6.5 |
| Treatment time [min] | 15 | 15 | 15 | 15 | 15 | 15 | 15 | 15 | 15 | 15 |
| NaCl content of soaping | 10 | 10 | 10 | 10 | 10 | 10 | 10 | 10 | 10 | 10 |
| bath [g/l] | | | | | | | | | | |
| Depth of shade of | 13.5 | 13.6 | 34.2 | 41.3 | 6.0 | 4.7 | 12.7 | 12.9 | 0.2 | 0.2 |
| aftercleared sample | | | | | | | | | | |

| | Example | | | | | | | | |
|---|---|---|---|---|---|---|---|---|---|
| | 11 | 12 | V13 | V14 | 15 | 16 | 17 | 18 | 19 |
| Hydrolyzate No. | H3 | H5 | H1 | H1 | H1 | H1 | H1 | H1 | H1 |
| Amount of hydrolyzate | 1.25 | 1.25 | 3.75 | 3.75 | 3.75 | 3.75 | 3.75 | 3.75 | 3.75 |
| used [g] | | | | | | | | | |
| Depth of shade of | 100 | 100 | 100 | 100 | 100 | 100 | 100 | 100 | 100 |
| padded textile | | | | | | | | | |
| Aftersoaping agent | S2 | S2 | S1 | S1 | S3 | S3 | S4 | S4 | S5 |
| Amount of aftersoaping | 2 | 2 | 2 | 2 | 2 | 2 | 2 | 2 | 2 |
| agent used [g/l] | | | | | | | | | |
| Number of soaping baths | 2 | 2 | 2 | 2 | 2 | 2 | 2 | 2 | 2 |
| Temperature of soaping | 98 | 98 | 98 | 98 | 98 | 98 | 98 | 98 | 98 |
| bath/baths [° C.] | | | | | | | | | |
| pH | 11 | 11 | 6.5 | 11 | 6.5 | 11 | 6.5 | 11 | 6.5 |
| Treatment time [min] | 15 | 15 | 15 | 15 | 15 | 15 | 15 | 15 | 15 |
| NaCl content of soaping | 10 | 10 | 10 | 10 | 10 | 10 | 10 | 10 | 10 |
| bath [g/l] | | | | | | | | | |
| Depth of shade of | 0.22 | 0.04 | 19.02 | 17.36 | 1.7 | 1.57 | 7.89 | 3.07 | 1.15 |
| aftercleared sample | | | | | | | | | |

| | Example | | | | | | | | | |
|---|---|---|---|---|---|---|---|---|---|---|
| | 20 | 21 | 22 | 23 | 24 | V25 | V26 | V27 | 28 | 29 |
| Hydrolyzate No. | H1 | H1 | H1 | H1 | H1 | H1 | H1 | H1 | H1 | H1 |
| Amount of hydrolyzate | 3.75 | 3.75 | 3.75 | 3.75 | 3.75 | 3.75 | 3.75 | 3.75 | 3.75 | 3.75 |
| used [g] | | | | | | | | | | |
| Depth of shade of | 100 | 100 | 100 | 100 | 100 | 100 | 100 | 100 | 100 | 100 |
| padded textile | | | | | | | | | | |
| Aftersoaping agent | S5 | S6 | S6 | S7 | S7 | S1 | S1 | S1 | S5 | S5 |
| Amount of aftersoaping | 2 | 2 | 2 | 2 | 2 | 2 | 2 | 2 | 2 | 2 |
| agent used [g/l] | | | | | | | | | | |
| Number of soaping baths | 2 | 2 | 2 | 2 | 2 | 2 | 2 | 2 | 2 | 2 |
| Temperature of soaping | 98 | 98 | 98 | 98 | 98 | 98 | 80 | 60 | 98 | 80 |
| bath/baths [° C.] | | | | | | | | | | |
| pH | 11 | 6.5 | 11 | 6.5 | 11 | 6.5 | 6.5 | 6.5 | 6.5 | 6.5 |
| Treatment time [min] | 15 | 15 | 15 | 15 | 15 | 15 | 15 | 15 | 15 | 15 |
| NaCl content of soaping | 10 | 10 | 10 | 10 | 10 | 10 | 10 | 10 | 10 | 10 |
| bath [g/l] | | | | | | | | | | |
| Depth of shade of | 0.3 | 1.79 | 0.81 | 0.2 | 0.1 | 19.5 | 20.5 | 26.4 | 1.07 | 2.02 |
| aftercleared sample | | | | | | | | | | |
| | Example | | | | | | | | | |
| | 30 | V31 | V32 | V33 | 34 | 35 | V37 | V38 | V39 | 36 |
| Hydrolyzate No. | H1 | H1 | H1 | H1 | H1 | H1 | H1 | H1 | H1 | H1 |
| Amount of hydrolyzate | 3.75 | 3.75 | 3.75 | 3.75 | 3.75 | 3.75 | 3.75 | 3.75 | 3.75 | 3.75 |
| used [g] | | | | | | | | | | |
| Depth of shade of | 100 | 100 | 100 | 100 | 100 | 100 | 100 | 100 | 100 | 100 |
| padded textile | | | | | | | | | | |
| Aftersoaping agent | S5 | S1 | S1 | S1 | S5 | S5 | S5 | S5 | S5 | S5 |
| Amount of aftersoaping | 2 | 2 | 2 | 2 | 2 | 2 | 2 | 2 | 2 | 2 |
| agent used [g/l] | | | | | | | | | | |
| Number of soaping baths | 2 | 2 | 2 | 2 | 2 | 2 | 2 | 2 | 2 | 2 |
| Temperature of soaping | 60 | 98 | 80 | 60 | 98 | 80 | 98 | 80 | 60 | 60 |
| bath/baths [° C.] | | | | | | | | | | |
| pH | 6.5 | 11 | 11 | 11 | 11 | 11 | 6.5 | 6.5 | 6.5 | 11 |
| Treatment time [min] | 15 | 15 | 15 | 15 | 15 | 15 | 15 | 15 | 15 | 15 |
| NaCl content of soaping | 10 | 10 | 10 | 10 | 10 | 10 | 30 | 30 | 30 | 10 |
| bath [g/l] | | | | | | | | | | |
| Depth of shade of | 1.80 | 20.7 | 21.8 | 28.8 | 0.41 | 1.66 | 47.5 | 46.7 | 55.7 | 1.96 |
| aftercleared sample | | | | | | | | | | |

| | Example | | | | | | | | | | |
|---|---|---|---|---|---|---|---|---|---|---|---|
| | 40 | 41 | 42 | V43 | V44 | V45 | 46 | 47 | 48 | V49 | V50 |
| Hydrolyzate No. | H1 | H1 | H1 | H1 | H1 | H1 | H1 | H1 | H1 | H1 | H1 |
| Amount of hydrolyzate | 3.75 | 3.75 | 3.75 | 3.75 | 3.75 | 3.75 | 3.75 | 3.75 | 3.75 | 3.75 | 3.75 |
| used [g] | | | | | | | | | | | |
| Depth of shade of | 100 | 100 | 100 | 100 | 100 | 100 | 100 | 100 | 100 | 100 | 100 |
| padded textile | | | | | | | | | | | |
| Aftersoaping agent | S5 | S5 | S5 | S1 | SI | S1 | S5 | S5 | S5 | S1 | S1 |
| Amount of aftersoaping | 2 | 2 | 2 | 2 | 2 | 2 | 2 | 2 | 2 | 2 | 2 |
| agent used [g/l] | | | | | | | | | | | |
| Number of soaping baths | 1 | 1 | 1 | 2 | 2 | 2 | 2 | 2 | 2 | 1 | 1 |
| Temperature of soaping | 98 | 80 | 60 | 98 | 80 | 60 | 98 | 80 | 60 | 98 | 80 |
| bath/baths [° C.] | | | | | | | | | | | |
| pH | 6.5 | 6.5 | 6.5 | 6.5 | 6.5 | 6.5 | 6.5 | 6.5 | 6.5 | 11 | 11 |
| Treatment time [min] | 15 | 15 | 15 | 15 | 15 | 15 | 15 | 15 | 15 | 15 | 15 |
| NaCl content of soaping | 30 | 30 | 30 | 30 | 30 | 30 | 30 | 30 | 30 | 30 | 30 |
| bath [g/l] | | | | | | | | | | | |
| Depth of shade of | 15.3 | 16.1 | 16.1 | 33.7 | 38.6 | 47.6 | 3.5 | 5.8 | 6.2 | 45.2 | 57.6 |
| aftercleared sample | | | | | | | | | | | |

| | Example | | | | | | | | | |
|---|---|---|---|---|---|---|---|---|---|---|
| | V51 | 52 | 53 | 54 | V55 | V56 | V57 | 58 | 59 | 60 |
| Hydrolyzate No. | H1 | H1 | H1 | H1 | H1 | H1 | H1 | H1 | H1 | H1 |
| Amount of hydrolyzate | 3.75 | 3.75 | 3.75 | 3.75 | 3.75 | 3.75 | 3.75 | 3.75 | 3.75 | 3.75 |
| used [g] | | | | | | | | | | |
| Depth of shade of | 100 | 100 | 100 | 100 | 100 | 100 | 100 | 100 | 100 | 100 |
| padded textile | | | | | | | | | | |
| Aftersoaping agent | S1 | S5 | S5 | S5 | S1 | S1 | S1 | S5 | S5 | S5 |
| Amount of aftersoaping | 2 | 2 | 2 | 2 | 2 | 2 | 2 | 2 | 2 | 2 |
| agent used [g/l] | | | | | | | | | | |
| Number of soaping baths | 1 | 1 | 1 | 1 | 1 | 1 | 1 | 1 | 1 | 1 |
| Temperature of soaping | 60 | 98 | 80 | 60 | 98 | 80 | 60 | 98 | 80 | 60 |
| bath/baths [° C.] | | | | | | | | | | |
| pH | 11 | 11 | 11 | 11 | 11 | 11 | 11 | 11 | 11 | 11 |
| Treatment time [min] | 15 | 15 | 15 | 15 | 15 | 15 | 15 | 15 | 15 | 15 |
| NaCl content of soaping | 30 | 30 | 30 | 30 | 30 | 30 | 30 | 30 | 30 | 30 |
| bath [g/l] | | | | | | | | | | |
| Depth of shade of | 49.0 | 12.2 | 14.2 | 12.1 | 35.7 | 38.2 | 43.9 | 2.8 | 4.7 | 5.6 |
| aftercleared sample | | | | | | | | | | |

Print pastes D1 to D8 were produced by stirring 80 g of Manutex F 700) alginate, 10 g of sodium p-nitrosulfonate, 100 g of urea and 25 g of Na₂CO₃ and 5 g of sodium hexametaphosphate water softener and 20 g of dye hydrolyzate according to table 1 together to form a print paste. The print pastes D1 to D8 thus obtainable had a dynamic viscosity of 3 Pa·s.

Each of the print pastes D1 to D8 was printed on an MBK flat screen printing table equipped with a magnetic squeegee system (squeegee diameter 10 mm; 12 m/min; 6 strokes) by means of an E50-55 gauze flat screen onto 100% woven cotton fabric. This was followed by drying in a circulating air cabinet from Mathis at 80° C. to complete dryness of the print.

The prints were then fixed in a Mathis GD laboratory HT steamer at 102° C. in a water vapor saturated atmosphere in the course of 10 min. After steaming, the printed samples were sent for aftersoaping.

### 2.3.5. Aftersoaping Tests

The table 3 level of the table 2 aftersoaping agent were dissolved with 50 g of sodium chloride in 1 l of water and adjusted to 10° German hardness with CaCl₂. 200 ml of the liquor thus obtained were temperature controlled to 60° C. Citric acid was used if necessary to adjust the pH to the value reported in table 3. The liquor was entered with 10 g of a printed textile and heated over 10 min to the temperature reported in table 3. Each soaping bath was allowed to act for 15 min before cooling down to 60° C., and in those examples where more than one soaping bath was used the liquor was in each case disposed of after the first soaping bath and a new soaping bath was set. In the experiments, to this end the second soaping bath in each case with identical composition was used. The textile was removed and expressed by hand. This was followed by two rinses with 200 ml of cold water each time for 5 minutes each time. This is followed by whizzing and drying of the sample at room temperature.

The afterclearing effect was evaluated as follows.

The reflectance spectrum was recorded with an X-rite CA22 spectrometer for the printed, dried textile as reference and then for the untreated textile. The Kubelka-Munk K/S values were calculated for both. Subsequently, the K/S values of the untreated textile were deducted from the printed, dried textile to obtain the pure dye contribution to the K/S value of the printed, dried textile.

The same procedure was carried out with the aftercleared sample to obtain the pure dye contribution to the K/S value of the aftercleared textile.

The obtained pure dye contributions to the K/S values were then ratioed in the region of the peak of the wavelength-dependent depiction of the K/S values of the printed, dried textile. For this, the K/S value of the printed, dried textile was set equal to 100%. The higher the K/S value of the aftercleared textile compared with the nonaftercleared printed, dried textile, the worse the aftersoaping performance.

The aftersoaping agents used were the substances or mixtures S1 to S8 reported below in table 4.

TABLE 6
Inventive afterclearing examples and comparative (V) examples

| | V61 | V62 | V63 | 64 | 65 | 66 | 67 |
|---|---|---|---|---|---|---|---|
| Hydrolyzate No. | H5 | H5 | H5 | H5 | H5 | H5 | H5 |
| Amount of hydrolyzate used [g/l] | 20 | 20 | 20 | 20 | 20 | 20 | 20 |
| Depth of shade of printed textile % | 100 | 100 | 100 | 100 | 100 | 100 | 100 |
| Aftersoaping agent | | S1 | S1 | S7 | S5 | S5 | S5 |
| Number of soaping baths | 1 | 1 | 1 | 1 | 1 | 1 | 1 |
| Soaping bath/baths temperature [° C.] | 98 | 98 | 98 | 98 | 98 | 98 | 98 |
| Amount of soaping agent used [g/l] | | 1 | 2 | 1 | 1 | 2 | 1 |
| pH | 6.5 | 6.5 | 6.5 | 6.5 | 6.5 | 6.5 | 6.5 |
| Treatment time [min] | 10 | 10 | 10 | 10 | 10 | 10 | 10 |
| Soaping bath NaCl content [g/l] | — | — | — | — | — | — | 15 |
| K/S value of aftercleared sample | 0.38 | 0.43 | 0.50 | 0.02 | 0.04 | 0.02 | 0.05 |

1. A method comprising utilizing copolymers containing units derived from at least 2 monoethylenically unsaturated monomers B1 and B2 which each contain at least one nitrogenous heterocycle, as leveling agents for textile dyeing and textile printing.

2. A method comprising utilizing graft polymers as an auxiliary for textile dyeing and textile printing, wherein at least one graft polymer is constructed from
a polymeric grafting base A which contains no monoethylenically unsaturated units, and
polymeric side chains B formed from copolymers of at least two monoethylenically unsaturated monomers B1 and B2 which each contain at least one nitrogenous heterocycle and optionally further comonomers B3, and said side chains B account for more than 35% by weight fraction of said graft polymer.

3. The method as claimed in claim 2, wherein the auxiliaries for textile dyeing are selected from the group consisting of stripping agents, leveling agents and aftersoaping agents.

4. The method as claimed in claim 2, wherein said polymeric grafting base A is a polyether.

5. A stripping agent comprising at least one graft polymer constructed from a polymeric grafting base A which contains no monoethylenically unsaturated units, and polymeric side chains B formed from copolymers of at least two monoethylenically unsaturated monomers B1 and B2 which each contain at least one nitrogenous heterocycle and optionally further comonomers B3, wherein said side chains B account for more than 35% by weight fraction of said graft polymer.

6. A process for stripping off-shade dyeings off textile materials, which comprises using a stripping agent comprising at least one graft polymer which contains units derived from at least 2 monoethylenically unsaturated monomers B1 and B2 which each contain at least one nitrogenous heterocycle.

7. A leveling agent comprising at least one graft polymer constructed from a polymeric grafting base A which contains no monoethylenically unsaturated units, and polymeric side chains B formed from copolymers of at least two monoethylenically unsaturated monomers B1 and B2 which each contain at least one nitrogenous heterocycle and optionally further comonomers B3, wherein said side chains B account for more than 35% by weight fraction of said graft polymer.

8. The leveling agent as claimed in claim 7, wherein at least one copolymer is a graft polymer.

9. A process for leveling dyeings on textile materials, which comprises using a leveling agent comprising at least one copolymer which contains units derived from at least 2 monoethylenically unsaturated monomers B1 and B2 which each contain at least one nitrogenous heterocycle.

10. The process as claimed in claim 9, wherein at least one copolymer is a graft polymer.

11. An aftersoaping agent comprising at least one copolymer which contains units derived from at least 2 monoethylenically unsaturated monomers B1 and B2 which each contain at least one nitrogenous heterocycle.

12. The aftersoaping agent as claimed in claim 11, wherein at least one copolymer is a graft polymer.

13. A process for afterclearing dyed or printed textile, which comprises using at least one copolymer containing units derived from at least 2 monoethylenically unsaturated monomers B1 and B2 which each contain at least one nitrogenous heterocycle.

14. The process as claimed in claim 13, wherein at least one copolymer is a graft polymer.

15. The process as claimed in claim 14, wherein at least one graft polymer is constructed from
a polymeric grafting base A which contains no monoethylenically unsaturated units, and
polymeric side chains B formed from copolymers of at least two monoethylenically unsaturated monomers B1 and B2 which each contain at least one nitrogenous heterocycle and optionally further comonomers B3.

16. The process as claimed in claim 1, wherein said side chains B account for a more than 35% by weight fraction of said graft polymer.

17. The process as claimed in claim 14, wherein said polymeric grafting base A is a polyether.

18. The process as claimed in claim 14, which further comprises using at least one further component selected from complexing agents and nonionic surfactants.

19. The process as claimed in claim 14, operated at weakly acidic to neutral pH.
